(19) United States
(12) Patent Application Publication
(10) Pub. No.: US 2003/0158929 A1
(43) Pub. Date: Aug. 21, 2003

(54) Computer network policy compliance measurement, monitoring, and enforcement system and method

(76) Inventor: Shaun Charles McNerney, Colorado Springs, CO (US)

Correspondence Address: Law Office of Dale B. Halling, LLC, Suite 311, 24 South Weber Street, Colorado Springs, CO, 80903, US

(21) Appl. No.: 10/339,153

(22) Filed: Jan. 9, 2003

Related U.S. Application Data
(60) Provisional application No. 60/348,756, filed on Jan. 14, 2002.

(51) Int. Cl. G06F 15/173

(52) U.S. Cl. 709/223

(57) ABSTRACT

A computer network policy compliance measurement, monitoring, and enforcement system has a director running on a computer coupled to a network. A collector runs on a second computer that is coupled to the network. The collector determines a policy state of the second computer. An advisor is coupled to the collector and indicates the policy state of the second computer.

### RELATED APPLICATIONS

The present application claims priority from the provisional patent application entitled “Idiot Light Method and System for Monitoring, Advising, and Exposure Evaluation of Networked Computer Systems”, filed on Jan. 14, 2002, having application No. 60/348,756.

### FIELD OF THE INVENTION

The present invention relates generally to the field of computer software systems and more particularly to a computer network policy compliance measurement, monitoring, and enforcement system and method.

### BACKGROUND OF THE INVENTION

The number of corporations and individuals that use computer systems and connect their computer systems to data networks and to the Internet continues to rapidly grow. This growth in computer systems and data networks has resulted in the introduction of and the reliance on a growing number of services provided via data networks. This growth has resulted in a significant number of users with little to no technical experience on how the computer system or data network operates. This growth has also triggered an increase in the complexity of data networks and an increase in the risk of being exposed to a security or hacker threat or unauthorized access to sensitive information. Also, as computer systems and data networks become more powerful, they are made to perform more and increasingly complex tasks which makes it even more difficult for users to determine if everything is configured properly and securely, working correctly, and operating within defined corporate policies and guidelines.

This has resulted in a number of products that monitor security procedures, the performance of computers systems and the network. These products commonly have a monitoring system connected to the local area network. The monitoring system monitors the local area network and the computer systems attached to the network. This centralized approach to monitoring security procedures, the performance of computers systems and the network results in a skewed perspective and does not provide any immediate feedback to the users of the computer systems. The monitoring system determines how the network is working from its perspective not the computer user's perspective. In addition, as the number of computers and other systems are attached to the network the monitoring system's tasks increase. This results in significant rework effort for the network administrator.

Thus there exists a need for a system that provides immediate feedback to users and provides an understanding of how the network is working and if the network and computer system are properly configured, secured and operating within defined (established) policies from the user's perspective.

### SUMMARY OF INVENTION

A computer network policy compliance measurement, monitoring, and enforcement system, that overcomes these and other problems has a director running on a computer coupled to a network. A collector runs on a second computer that is coupled to the network. The collector determines a policy state of the second computer. An advisor is coupled to the collector and indicates the policy state of the second computer. In one embodiment, the director is coupled to a database. The database stores policy history data. In another embodiment, the collector has a configuration component and a monitoring component. The configuration component determines a configuration of a computer and compares against a known baseline. The monitoring component monitors an operating system of the second computer, the network, a variety of user experiences and a plurality of system resources.

In one embodiment, the advisor displays a visual indicator of the policy state of the second computer. In another embodiment, the advisor transmits a notification of the security state of the second computer. In yet another embodiment, the advisor closes down the second computer based on the policy state of the second computer.

In one embodiment, a method of operating a computer network policy compliance measurement, monitoring, and enforcement system includes the steps of determining a configuration policy for a computer coupled to a network from a number of sources. Next a state of the computer is monitored by a collector. An indication of the state of the computer by an advisor is provided. In one embodiment, a configuration information is received from a director.

In one embodiment, a state information is transmitted to a director.

In another embodiment, an icon is provided that indicates the state of the computer. When the icon is selected by a user, a plurality of indicators are provided on a state of portions of the computer or the network. When one of the plurality of indicators is selected, a detailed information or advice on a related portion of the state of the computer or the network is provided.

In one embodiment, a computer network policy compliance measurement, monitoring, and enforcement system has a director running on a computer coupled to a network, the director storing a configuration information. A number of collectors are coupled to the network and receives the configuration information from the director. The collectors are running on one of the computers. Each of the collectors determines a security state of one of the computers. A number of advisors are coupled to the collectors. Each of the advisors indicates the security state of one of the computers. In one embodiment, a remote collector runs on a computer. The remote collector receives security information from one of the collectors.

In one embodiment, a remote advisor runs on the computer of the remote collector. The remote advisor indicates the security information from one of the collectors. In one embodiment, each of the collectors monitors a portion of the network and provides network information to the advisors.

In one embodiment, each of the collectors monitors system resources of the computers.

In one embodiment, the advisors provide an indicator of a state of the computers.

In another embodiment, The advisors provide detailed information related to each of the indictors of the state of the computers.

### BRIEF DESCRIPTION OF THE DRAWINGS

FIG. 1 is a block diagram of a computer network policy compliance measurement, monitoring, and enforcement system in accordance with one embodiment of the invention;

FIG. 2 is a block diagram of collector in accordance with one embodiment of the invention;

FIG. 3 is a screen shot of an advisor screen in accordance with one embodiment of the invention; and

FIG. 4 is a flow chart of a method of operating a computer network policy compliance measurement, monitoring, and enforcement system in accordance with one embodiment of the invention.

### DETAILED DESCRIPTION OF THE DRAWINGS

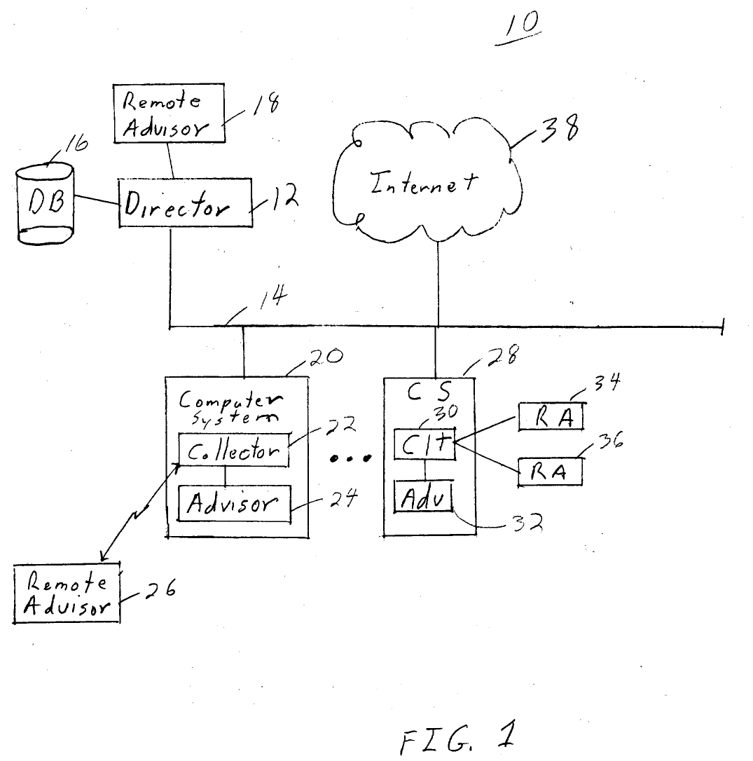

FIG. 1 is a block diagram of a computer network policy compliance measurement, monitoring, and enforcement system 10 in accordance with one embodiment of the invention. The system 10 has a director 12, which in one embodiment is a process running on a computer system. The director 12 is coupled to a data network 14. The director 12 is also coupled to a database 16 and a remote advisor 18. In one embodiment, the remote advisor 18 is a computer process that runs on the same computer as the director 12. A second computer system 20 is connected to the data network 14. In one embodiment, a collector 22 is a computer process that runs on the second computer system 20. The collector 22 is coupled to an advisor 24. The collector 22 may be connected to a remote advisor 26. The connection to the remote advisor may be wireless or wired and be continuously connected or intermittent. Another computer system 28 is also connected to the data network 14. This computer system 28 also has a collector 30 coupled to an advisor 32. In one embodiment, the collector 30 is coupled to a pair of remote advisors 34, 36. The data network 14 may be connected to the internet 38.

The system 10 is designed to provide a neighborhood watch approach to computer network policy, security and monitoring. A neighborhood watch approach involves participation of (engagement of) every computer system and ever user in computer network policy compliance, measurement, monitoring and enforcement. Every computer system 20, 28 connected to the data network 14 has a collector 22, 30 that collects a variety of policy, security and monitoring information. The collectors 22, 30 pass this information on to the advisor 24, 32 or remote advisor 26, 34, 36. The advisor 24, 32 determines what action should be taken based on the information. In one embodiment, when there are no issues the advisor displays a green light. When minor issues are detected the advisor displays a yellow light and a red light when major issues are detected. In one embodiment, the advisor may shut down a computer system for certain policy breaches. In one embodiment, the user may click on the icon with the color coding. This provides more detailed information about specific systems.

In one embodiment, a summary of the policy information is transmitted to the director 12. This information may be stored in the database 16. The director 12 may also have a variety of security or configuration information that the computer systems 20, 28 may access. The director 12 aggregates the information from the computer systems and provides an organization wide view.

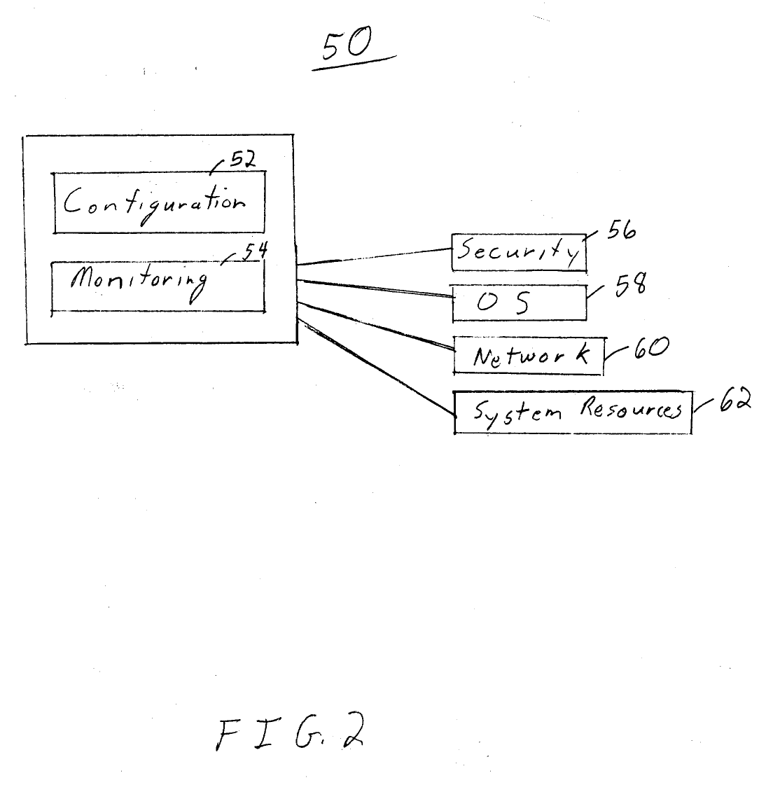

FIG. 2 is a block diagram of collector 50 in accordance with one embodiment of the invention. The collector 50 has a configuration component 52. The configuration component 52 determines a number of policies for the computer system. For instance, the configuration component 52 may specify that the user is required to change their password every month. The configuration component 52 may also specify the allowable software on the computer system. The collector 50 also has a monitoring component 54. The monitoring component 54 monitors the security issues 56, operating system issues 58, network issues 60, system resource issues 62 and may monitor other aspects of the network or computer system. An example of a security issue is the detection of a virus. An example of an operating system issue is password compliance. An example of a network issue is monitoring that the email server is up. An example of a system resource is determining if the computer system is running low on memory.

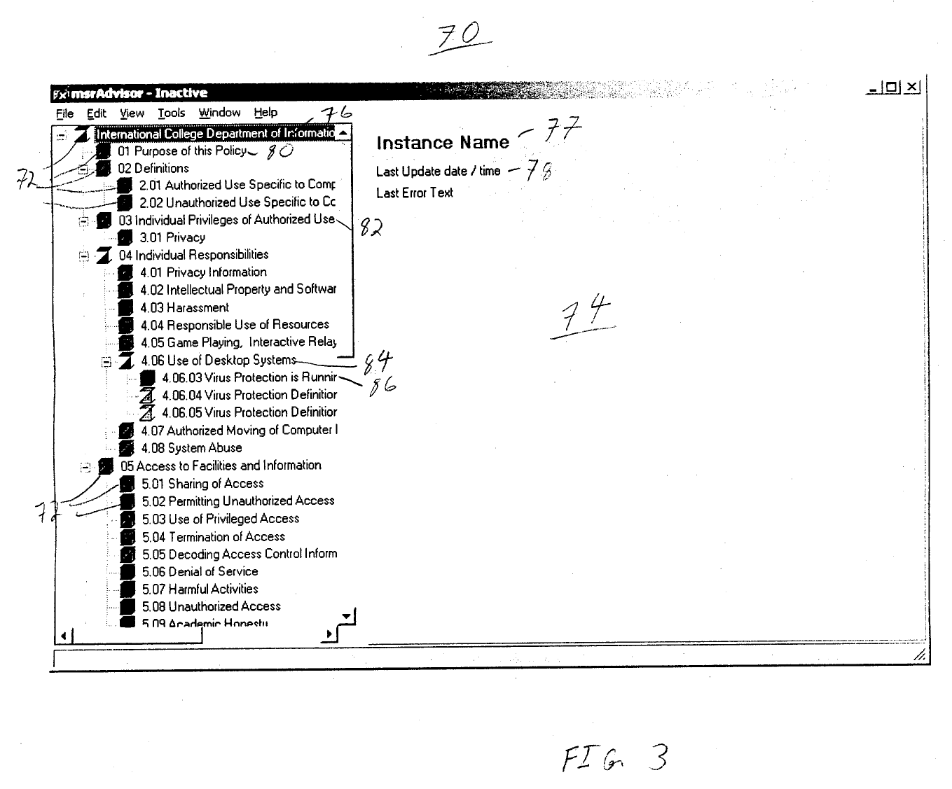

FIG. 3 is a screen shot of an advisor screen 70 in accordance with one embodiment of the invention. The screen shot shows the more detailed information that a user would obtain by clicking the color coded icon. The screen shot shows a tree structure with an icon 72 at the beginning of each branch of the tree. Each icon 72 may also be color coded. This allows the user to quickly determine which item is causing the problem. When a user selects one of the icons 72 they are provided more detailed information, in the dialog box section 74. In this example, the configuration information 76 is selected. The configuration information 76 is for a fictitious customer and the dialog box 74 shows where a version number 77 would appear and the last time 78 the information 74 was updated. The next branch 80 of the tree would explain the purpose of the policy. The branch 82 entitled individual privileges of authorized use defines and monitors who may use the computer system and how they may use the system. For instance, the computer system may allow a person on the computer system but may not allow them to alter certain files. Another branch 84 of the tree determines 86 if the virus protection software is running. Since the computer system monitors these activities locally it provides feedback on the user's experience.

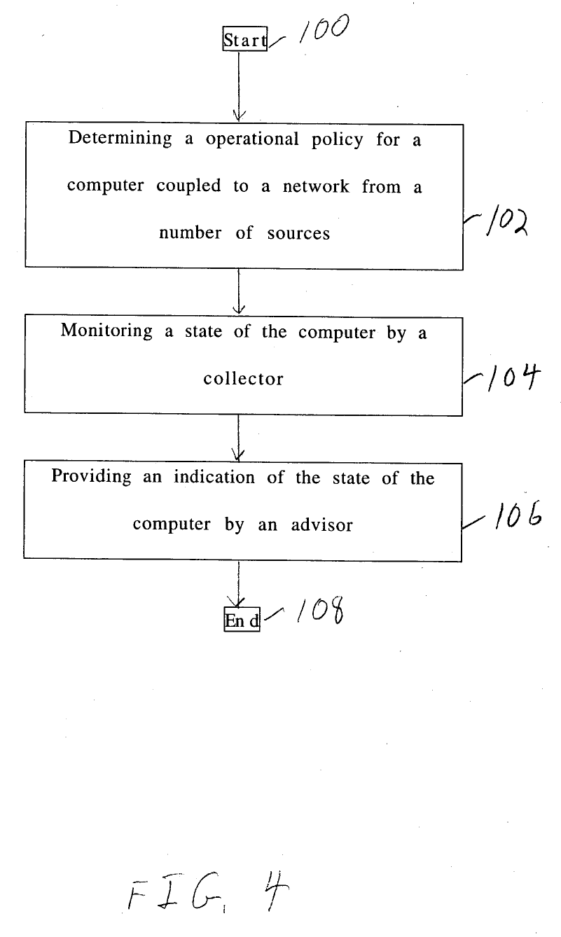

FIG. 4 is a flow chart of a method of operating a computer network policy compliance measurement, monitoring, and enforcement system in accordance with one embodiment of the invention. The method starts, step 100, by determining a operational policy for a computer at step 102. The computer is coupled to a network and the operational policy information is derived from a variety sources. A state of the computer is monitored by a collector at step 104. At step 106, an indication of the state of the computer is provided by the advisor which ends the process at step 108. In one embodiment, the indication may be a visual indicator, an audio indicator or an electronic page.

Thus there has been described a system that provides immediate feedback to users and provides an understanding of how the network is working from the user perspective.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A computer network policy compliance measurement, monitoring, and enforcement system, comprising:
a director running on a computer coupled to a network;
a collector running on a second computer coupled to the network, the collector determining a policy state of the second computer; and
an advisor coupled to the collector and indicating the policy state of the second computer.

2. The system of claim 1, wherein the director is coupled to a database, wherein the database stores a plurality of policy history data.

3. The system of claim 1, wherein the collector has a configuration component and a monitoring component.

4. The system of claim 3, wherein the configuration component determines a configuration of a computer.

5. The system of claim 3, wherein the monitoring component monitors an operating system of the second computer, the network, a variety of user experiences and a plurality of system resources.

6. The system of claim 1, wherein the advisor displays a visual indicator of the policy state of the second computer.

7. The system of claim 1, wherein the advisor transmits a notification of the policy state of the second computer.

8. The system of claim 1, wherein the advisor closes down the second computer based on the policy state of the second computer.

9. A method of operating a computer network policy compliance measurement, monitoring, and enforcement system, comprising the steps of:
a) determining a operational policy for a computer coupled to a network from a number of sources;
b) monitoring a state of the computer by a collector; and
c) providing an indication of the state of the computer by an advisor.

10. The method of claim 9, wherein step (a) further includes the step of:
a1) receiving a configuration information from a director.

11. The method of claim 9, further including the step of:
d) transmitting a state information to a director.

12. The method of claim 9, further including the step of:
d) providing an icon that indicates the state of the computer;
e) when the icon is selected by a user, providing a plurality of indicators on a state of portions of the computer or the network.

13. The method of claim 12, further including the step of:
f) when one of the plurality of indicators is selected providing a detailed information or advice on a related portion of the state of the computer or the network.

14. A computer network policy compliance measurement, monitoring, and enforcement system, comprising:
a director running on a computer coupled to a network, the director storing an operational information;
a plurality of collectors coupled to the network and receiving the operational information from the director, each of the plurality of collectors running on one of a plurality of computers, each of the plurality of collectors determining at least a operational state of each of the plurality of computers; and
a plurality of advisors, each coupled to one of the plurality of collectors, each of the plurality of advisors indicating at least the operational state of one of the plurality of computers.

15. The system of claim 14, further including a remote collector running on a computer, the remote collector receiving an operational information from one or more of the plurality of collectors.

16. The system of claim 15, further including a remote advisor running on the computer of the remote collector, the remote advisor indicating the operational information from one or more of the plurality of collectors.

17. The system of claim 14, wherein each of the plurality of collectors monitors a portion of the network and provides a network information to each of the plurality of advisors.

18. The system of claim 14, wherein each of the plurality of collectors monitors a system resources of the one of the plurality of computers.

19. The system of claim 14, wherein each of the advisors further provide a plurality of indicators of a state of one of the plurality of computers.

20. The system of claim 19, wherein each of the advisors provides a detailed information related to each of the plurality of indictors of the state of one of the plurality of computers.
